(19) United States
(12) Patent Application Publication
(10) Pub. No.: US 2023/0283894 A1
(43) Pub. Date: Sep. 7, 2023

(54) IMAGE PICKUP SYSTEM AND IMAGE PICKUP METHOD

(71) Applicants: Kabushiki Kaisha Toshiba, Tokyo (JP); Toshiba Electronic Devices & Storage Corporation, Tokyo (JP)

(72) Inventor: Koji RYUGO, Yokohama Kanagawa (JP)

(21) Appl. No.: 17/888,145

(22) Filed: Aug. 15, 2022

(30) Foreign Application Priority Data
Mar. 4, 2022 (JP) 2022-033425

(51) Int. Cl. H04N 5/232; H04N 5/225; G01S 3/46; G03B 5/00; G02B 27/00

(52) U.S. Cl. CPC H04N 5/232061; H04N 5/23299; H04N 5/23296; H04N 5/23245; H04N 5/2254; G01S 3/46; G03B 5/00; G02B 27/0081; G03B 17/14

(57) ABSTRACT

An image pickup system according to embodiments includes an image pickup unit, a receiving unit, an operation unit, and a determination unit. The image pickup unit picks up an optical image formed by an optical system by means of an image pickup element to obtain an image. The receiving unit receives a radio signal including unique information transmitted from a transmitter to output the received signal. The operation unit operates an arrival angle of the radio signal based on the received signal. The determination unit determines, based on the arrival angle, whether or not the transmitter is within an angle of view of the image.

### CROSS-REFERENCE TO RELATED APPLICATIONS

This application is based upon and claims the benefit of priority from the prior Japanese Patent Application No. 2022-033425 filed in Japan on Mar. 4, 2022; the entire contents of which are incorporated herein by reference.

### FIELD

Embodiments described herein relate generally to an image pickup system and an image pickup method for picking up an optical image to obtain an image.

### BACKGROUND

A technology is proposed in which an image pickup system configured to pick up an optical image to obtain an image detects whether or not a specific subject is within an image.

As an example of such a technology, there is an automatic tracking device configured to scan a beam of a first radio wave from a camera and to return a second radio wave including unique information when a radio wave responder of a subject receives the first radio wave.

### BRIEF DESCRIPTION OF THE DRAWINGS

FIG. 1 is a block diagram of a configuration of an image pickup system according to a first embodiment;

FIG. 2 is a view showing the image pickup system according to the first embodiment and a subject;

FIG. 3 is a view for illustrating an operation method of an arrival angle in the image pickup system according to the first embodiment;

FIG. 4 is a diagram of exemplary layouts of a receiving antenna according to the first embodiment;

FIG. 5 is a flowchart of an operation of the image pickup system according to the first embodiment;

FIG. 6 is a block diagram of a configuration of the image pickup system according to Modification 1 of the first embodiment:

FIG. 7 is a block diagram of a configuration of the image pickup system according to Modification 2 of the first embodiment;

FIG. 8 is a block diagram of a configuration of an image pickup system according to a second embodiment;

FIG. 9 is a view showing the image pickup system according to the second embodiment and the subject:

FIG. 10 is a flowchart of an operation of the image pickup system according to the second embodiment;

FIG. 11 is a block diagram of a configuration of the image pickup system according to a modification of the second embodiment;

FIG. 12 is a block diagram of a configuration of an image pickup system according to a third embodiment;

FIG. 13 is a flowchart of an operation of the image pickup system according to the third embodiment; and

FIG. 14 is a view showing the image pickup system according to the third embodiment and a plurality of subjects when a group photograph is taken.

### DETAILED DESCRIPTION

An image pickup system according to embodiments includes an image pickup unit, a receiving unit, an operation unit, and a determination unit. The image pickup unit picks up an optical image formed by an optical system by means of an image pickup element to obtain an image. The receiving unit receives a radio signal including unique information transmitted from a transmitter to output the received signal. The operation unit operates an arrival angle of the radio signal based on the received signal. The determination unit determines, based on the arrival angle, whether or not the transmitter is within an angle of view of the image.

Now, with reference to the drawings, the embodiments will be described.

### First Embodiment

### (Configuration)

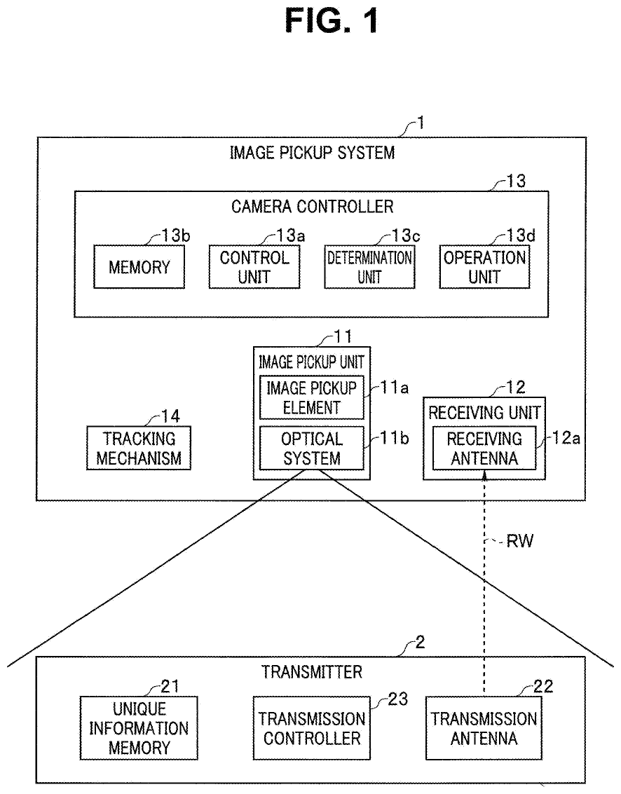

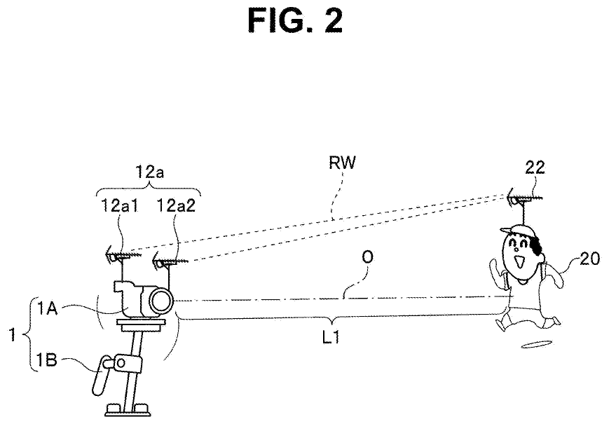

FIG. 1 is a block diagram of a configuration of an image pickup system 1 according to a first embodiment. FIG. 2 is a view showing the image pickup system 1 according to the first embodiment and a subject 20.

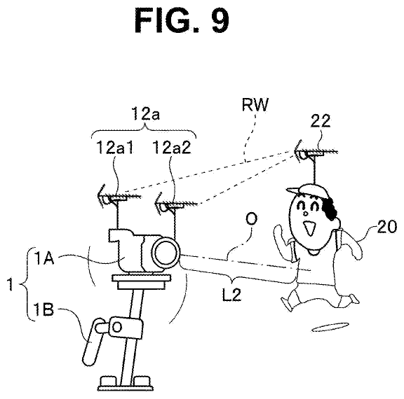

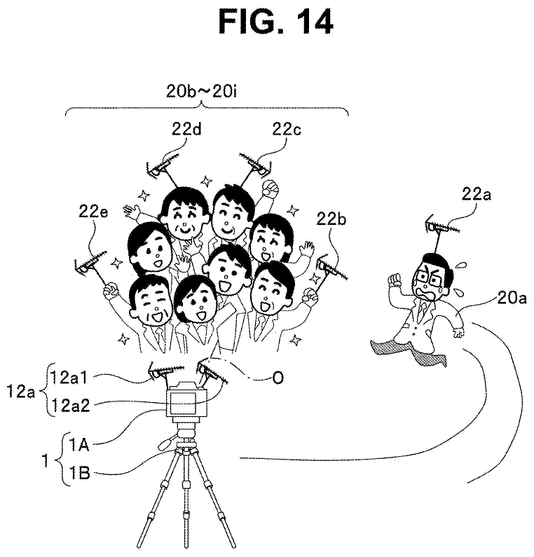

The image pickup system 1 includes a camera 1A (see FIG. 2 or the like) such as a still camera, a video camera, or a drone. As described later, the image pickup system 1 may further include a camera assisting device 1B (see FIG. 2, 6, 7, 9, 14 or the like) on which the camera 1A is installed. FIGS. 2 and 9 show an example of the camera assisting device 1B as a gimbal, and FIG. 14 shows an example of the camera assisting device 1B as a tripod.

A transmitter 2 is a tag configured to actively transmit a radio signal RW, and held by the subject 20. The subject 20 may be a living thing such as a person or an animal, or a non-living thing such as a car or a building, and is not limited to a specific thing as long as the thing can hold the transmitter 2. The transmitter 2 includes, for example, a unique information memory 21, a transmission antenna 22, and a transmission controller 23.

The unique information memory 21 stores unique information of the transmitter 2 in a non-volatile manner. The unique information is information unique to the individual transmitter 2, and sometimes referred to as identification information. An example of the unique information is unique ID (identification). If a plurality of subjects 20 hold respective transmitters 2, the transmitters 2 each have different unique information, and thus one subject 20 can be distinguished from the other subjects 20.

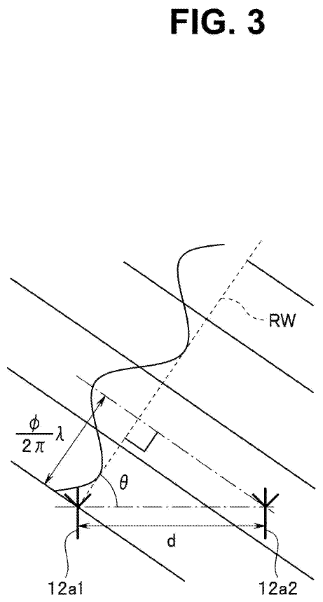

The transmission antenna 22 transmits a radio signal RW including unique information. The radio signal RW transmitted by the transmission antenna 22 includes azimuth measuring information, and the image pickup system 1 configured to receive the radio signal RW can measure an arrival angle θ (see FIG. 3) of the radio signal RW from the transmitter 2.

The transmission controller 23 reads the unique information from the unique information memory 21, and transmits the radio signal RW including the unique information and the azimuth measuring information from the transmission antenna 22.

A specific example of the transmitter 2 is a BLE (Bluetooth (registered trademark) low energy) radio transmitter (BLE beacon). The transmitter 2 is not limited to the BLE, but may be configured to transmit, for example, a UWB (ultra wide band) radio signal.

The transmitter 2 is not limited to a specific configuration, but may be a badge or a name tag worn by the subject 20 (or a collar if the subject 20 is an animal), or a smartphone held by the subject 20 may serve as a BLE beacon.

The image pickup system 1 makes an adjustment such that the subject 20 is within an angle of view of an image based on the radio signal RW transmitted from the transmitter 2 to pick up an image. The image picked up by the image pickup system 1 may be either a still image or a moving image.

As shown in FIG. 1, the image pickup system 1 according to the first embodiment includes an image pickup unit 11, a receiving unit 12, a camera controller 13, and a tracking mechanism 14.

The image pickup unit 11 includes an optical system 11b configured to form an optical image, and an image pickup element 11a configured to pick up an optical image to obtain an image.

The receiving unit 12 includes a receiving antenna 12a arranged in association with an optical axis O of the optical system 11b. The receiving unit 12 receives the radio signal RW including the unique information transmitted from the transmitter 2 by means of the receiving antenna 12a to output the received signal.

The receiving antenna 12a includes a plurality of antennas. FIGS. 2 and 3 show an example including an antenna 12al and an antenna 12a2.

The camera controller 13 includes a control unit 13a, a memory 13b, a determination unit 13c, and an operation unit 13d.

The operation unit 13d operates an arrival angle θ of the radio signal RW based on the received signal output from the receiving unit 12. With reference to FIG. 3, a principle of the operation unit 13d operating the arrival angle θ will be described. FIG. 3 is a view for illustrating an operation method of an arrival angle θ in the image pickup system 1 according to the first embodiment.

As shown in FIG. 3, the radio signal RW entering the receiving antenna 12a at the arrival angle θ is received by the antenna 12al and the antenna 12a2 in different phases. The antenna 12a1 and the antenna 12a2 are spaced apart by a known distance d. A wavelength of the radio signal R W is represented by λ, and a phase difference between the radio signal RW received by the antenna 12al and the radio signal RW received by the antenna 12a2 is represented by φ.

At this time, the operation unit 13d operates the arrival angle θ of the radio signal RW based on the phase difference p of the radio signal RW received by the plurality of antennas 12a1, 12a2 as expressed by the following equation (1);

(φλ/2πd)=cos θ (1)

Such an operation of the arrival angle θ is performed by, for example, an AoA (angle of arrival) that is a BLE radio propagation direction detecting function.

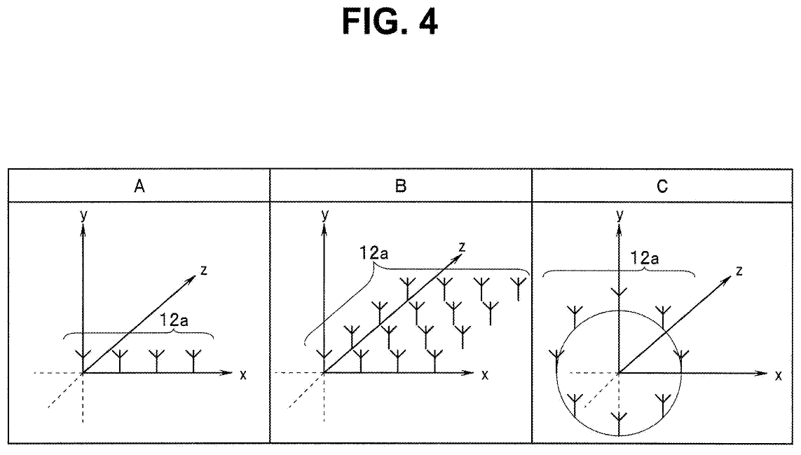

The receiving antenna 12a including two or more antennas allows measurement of the arrival angle θ with higher accuracy. FIG. 4 is a diagram of exemplary layouts of the receiving antenna 12a according to the first embodiment.

As shown in column A in FIG. 4, the receiving antenna 12a may include, for example, a plurality of antennas linearly arranged on an x axis. In this case, an arrival angle θx with respect to the x axis can be measured.

As shown in column B in FIG. 4, the receiving antenna 12a may include, for example, a plurality of antennas arranged in a grid on an x-z plane. In this case, an arrival angle θx with respect to an x axis can be measured from a phase difference of the plurality of antennas arranged in an x-axis direction, and an arrival angle θy with respect to a y axis can be measured from a phase difference of the plurality of antennas arranged in a y-axis direction. Thus, an arrival angle θ can be measured as an azimuth in an xyz space.

Further, as shown in column C in FIG. 4, the receiving antenna 12a may include, for example, a plurality of antennas arranged in a circle around an origin point on an x-y plane. Also in this case, an arrival angle θ can be measured as an azimuth in an xyz space.

FIG. 4 shows some exemplary layouts, but an antenna layout is not limited to the specific layouts as long as a positional relationship of the plurality of antennas is known.

The optical axis O of the optical system 11b of the image pickup unit 11 is directed in a known direction in the xyz space in FIG. 4. Then, the receiving antenna 12a with the antenna layout set in the xyz space is arranged in association with the optical axis O of the optical system 11b. Thus, an angle relationship between the optical axis O and the arrival angle θ of the radio signal RW can be measured.

The determination unit 13c determines, based on the arrival angle θ, whether or not the transmitter 2 is within an angle of view of an image. The angle of view of the image obtained by the image pickup element 11a of the image pickup unit 11 can be measured from a focal length of the optical system 11b, a size of an effective pixel region of the image pickup element 11a, or the like. If electronic zooming is performed, an angle of view of an image can be measured depending on from which part of the effective pixel region the image is obtained, in what image format (an aspect ratio of the image) the image is obtained, or what size of region is cut to obtain the image.

The determination unit 13c determines, based on the optical axis O of the optical system 11b, the arrival angle θ of the radio signal RW, and the angle of view of the image, whether or not the transmitter 2 that transmits the radio signal RW is within the angle of view.

The memory 13b stores various information including various parameters relating to the image pickup system 1 such as a focal length of the optical system 11b, an image format of the image pickup element 11a, or a size of an effective pixel region, and processing programs executed by the control unit 13a.

According to the processing programs stored in the memory 13b, the control unit 13a reads the various parameters to control components in the image pickup system 1.

The tracking mechanism 14 includes, for example, an actuator to change an image pickup direction of the image pickup unit 11. The image pickup direction is changed by the tracking mechanism 14, for example, by changing a direction of the optical axis O of the optical system 11b. However, not limited to such a method, the image pickup direction may be changed by shifting the image pickup element 11a in an image circle of the optical system 11b, or other methods may be used.

If the determination unit 13c determines that the transmitter 2 is not within the angle of view, the control unit 13a controls the tracking mechanism 14 to change the image pickup direction such that the transmitter 2 is within the angle of view.

### (Operation)

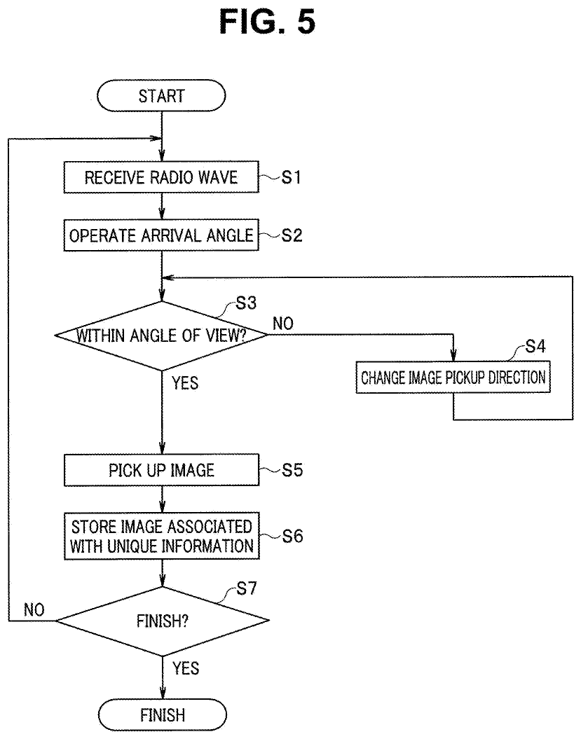

FIG. 5 is a flowchart of an operation of the image pickup system 1 according to the first embodiment.

When processing in FIG. 5 is started, the receiving unit 12 receives the radio signal RW transmitted from the transmitter 2 to output the received signal (step S1).

The control unit 13a checks, from the unique information included in the received signal, whether or not the transmitter 2 that has transmitted the radio signal RW is the transmitter 2 held by the subject 20 to be imaged. If it is checked that the transmitter 2 is the transmitter 2 held by the subject 20 to be imaged, the operation unit 13d operates an arrival angle θ (step S2).

The determination unit 13c determines, based on the arrival angle θ, whether or not the transmitter 2 is within the angle of view (step S3).

When it is determined that the transmitter 2 is not within the angle of view, the control unit 13a controls the tracking mechanism 14 to change the image pickup direction such that the transmitter 2 is within the angle of view (step S4).

Such automatic tracking is performed using the tracking mechanism 14, and if it is determined in step S3 that the transmitter 2 is within the angle of view, the image pickup unit 11 picks up an optical image of the subject 20 to obtain an image (still image or moving image) (step S5).

The control unit 13a stores the obtained image, for example, associated with unique information, in the memory 13b or an appropriate recording medium (step S6). By such processing, the unique information of the transmitter 2 held by the specific subject 20 is associated with the image, and thus the image showing the specific subject 20 can be easily searched for.

Then, the control unit 13a determines whether to finish the processing or to continue photographing (step S7). If it is determined to continue photographing, the process returns to step S1 and repeats the processing described above. Thus, the image pickup direction is repeatedly adjusted such that the transmitter 2 is continuously within the angle of view.

If it is determined to finish the processing, the processing in FIG. 5 is finished.

According to the first embodiment, the image pickup system 1 detects the radio signal RW including the unique information transmitted from the transmitter 2 held by the subject 20 to operate the arrival angle θ. This allows the image showing the specific subject 20 to be detected in a short time period. This can provide a low-cost image pickup system 1 and image pickup method.

### Modification 1 of First Embodiment

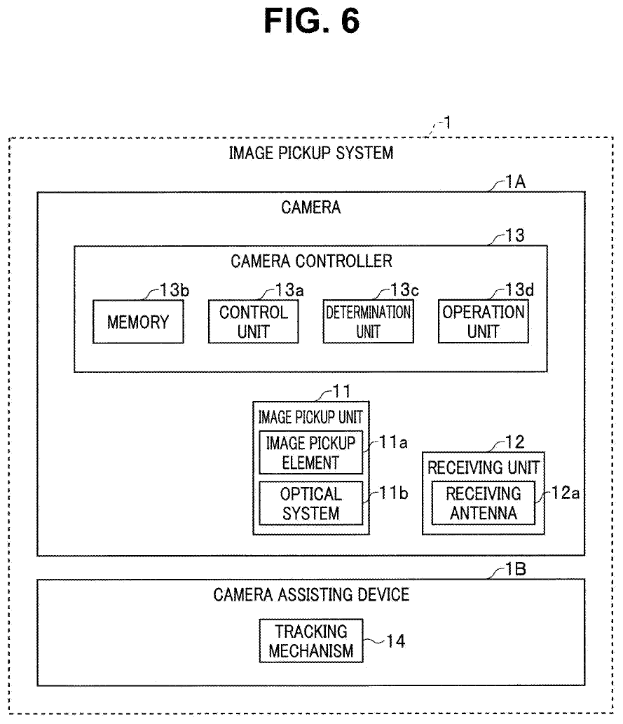

FIG. 6 is a block diagram of a configuration of the image pickup system 1 according to Modification 1 of the first embodiment.

In the configuration in FIG. 1, the tracking mechanism 14 is provided in the image pickup system 1, and may be provided, for example, in the camera 1A. In contrast, in Modification 1 in FIG. 6, the tracking mechanism 14 is provided in a camera assisting device 1B. The camera assisting device 1B is a device such as a tripod or a gimbal on which the camera 1A including the image pickup unit 11 is installed.

In Modification 1, the camera assisting device 1B supports the camera 1A, for example, rotatably around one or more axles. The tracking mechanism 14 includes an actuator or the like configured to rotate the camera 1A around the axle(s).

The camera assisting device 1B communicates with the camera 1A to obtain instructions on a rotation direction and a rotation amount, drives the actuator of the tracking mechanism 14 to adjust one or more of a yaw or a pitch (or further, a roll) of the camera 1A such that the subject 20 holding the transmitter 2 is within the angle of view.

Also if the camera assisting device 1B includes a mechanism configured to shift the camera 1A in one or more axial directions, the camera 1A may be shifted in addition to or instead of being rotated, such that the subject 20 holding the transmitter 2 is within the angle of view.

### Modification 2 of First Embodiment

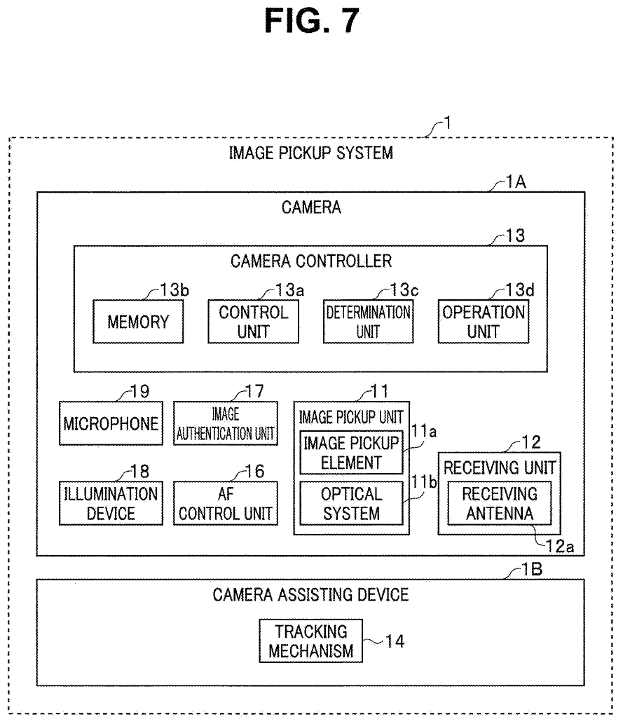

FIG. 7 is a block diagram of a configuration of the image pickup system 1 according to Modification 2 of the first embodiment.

In the camera 1A, in addition to the image pickup unit 11, the receiving unit 12, and the camera controller 13, an autofocus (AF) control unit 16, an image authentication unit 17, an illumination device 18, and a microphone 19 are provided.

The AF control unit 16 adjusts a focus position of the optical system 11b by means of, for example, contrast AF or phase difference AF.

The image authentication unit 17 performs image authentication processing of an image obtained by the image pickup unit 11, such as face authentication of a person or an animal.

The illumination device 18 emits illumination light toward the subject 20. Emitting the illumination light outside the angle of view wastes the light, and thus an emission range of the illumination light by the illumination device 18 is such as to cover the angle of view.

The microphone 19 collects voice around the image pickup system 1 and converts the voice into an electrical signal. The image pickup system 1 sometimes uses a microphone 19 with some directivity around the direction of the optical axis O to reduce voice collected from outside the angle of view as noise.

If the tracking mechanism 14 is provided in the camera assisting device 1B, when the tracking mechanism 14 changes the image pickup direction such that the transmitter 2 is within the angle of view, an illumination direction of the illumination device 18 and a voice collecting direction of the microphone 19 are also changed to the same direction as the image pickup direction. This can maintain a state in which the illumination device 18 emits the illumination light into the angle of view and a state in which the microphone 19 collects voice from the subject 20.

If the tracking mechanism 14 is provided in the camera 1A, the tracking mechanism 14 is preferably further configured to perform automatic tracking such that the illumination direction of the illumination device 18 and the voice collecting direction of the microphone 19 match the direction of the optical axis O.

In the above, the image pickup direction is adjusted such that the transmitter 2 is within the angle of view. However, the transmitter 2 is generally smaller than the subject 20 such as a person, and if the transmitter 2 is within the angle of view but at an edge within the angle of view, a part of the subject 20 to be imaged sometimes does not show up in an image. Thus, it is preferably ensured that the subject 20 holding the transmitter 2 is within the angle of view using a result of image authentication (such as face authentication) by the image authentication unit 17.

Further, the AF control unit 16 can perform an AF detection to find a distance to the subject 20. Finding the distance to the subject 20 allows estimation of a size of the subject 20 such as a person within an image. Thus, the control unit 13a may obtain distance information to the subject 20 from the AF control unit 16, and the control unit 13a may control the determination unit 13c to determine more accurately, based on the distance information, whether or not the subject 20 is within the angle of view.

### Second Embodiment

### (Configuration)

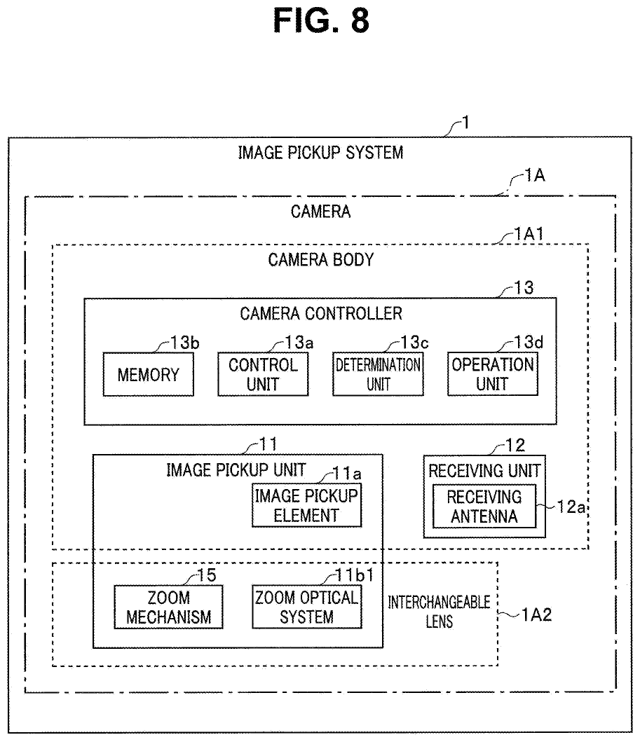

FIG. 8 is a block diagram of a configuration of an image pickup system 1 according to a second embodiment. In the second embodiment, the same components as in the first embodiment are denoted by the same reference numerals and descriptions of such components will be omitted, and differences will be mainly described.

The image pickup system 1 in FIG. 8 is such that the tracking mechanism 14 is omitted from the image pickup system 1 in FIG. 1 and a zoom mechanism 15 is provided in the image pickup unit 11. Also, a zoom optical system 11b1 capable of changing a focal length is adopted as the optical system 11b. The zoom mechanism 15 changes a focal length of the zoom optical system 11b1 to change an angle of view of an image obtained by the image pickup unit 11.

If the camera 1A is a lens interchangeable camera including a camera body 1A1 and an interchangeable lens 1A2 removably attached to the camera body 1A1, the image pickup element 11a may be provided in the camera body 1A1, and the zoom optical system 11b1 and the zoom mechanism 15 may be provided in the interchangeable lens 1A2.

FIG. 9 is a view showing the image pickup system 1 according to the second embodiment and the subject 20.

As compared to the example in FIG. 2, in an example in FIG. 9, the subject 20 has moved closer to the image pickup system 1. For example, a distance between the image pickup system 1 and the subject 20 is L1 in FIG. 2, while in FIG. 9, a distance between the image pickup system 1 and the subject 20 is L2 shorter than L1.

In the second embodiment, if the subject 20 holding the transmitter 2 is not within the angle of view, the angle of view is changed such that the subject 20 is within the angle of view.

### (Operation)

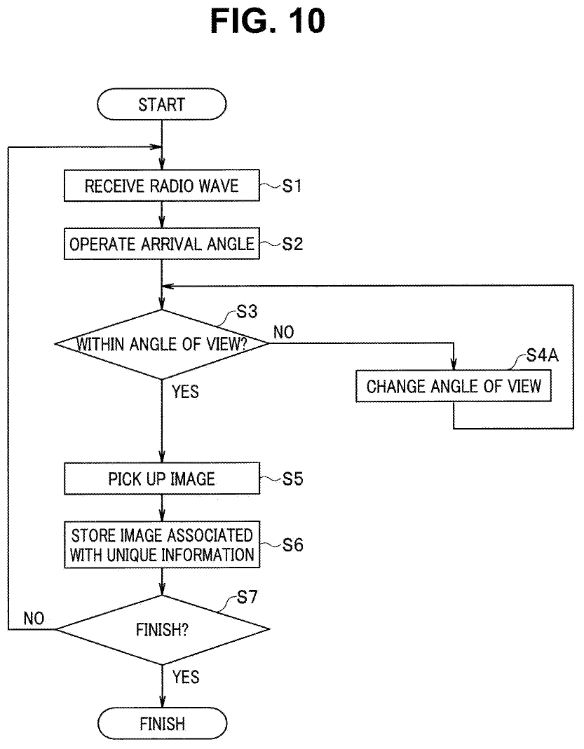

FIG. 10 is a flowchart of an operation of the image pickup system 1 according to the second embodiment.

When processing in FIG. 10 is started, processing in steps S1 to S3 as in FIG. 5 is performed.

If it is determined in step S3 that the transmitter 2 is not within the angle of view, the control unit 13a controls the zoom mechanism 15 to change the angle of view such that the transmitter 2 is within the angle of view (step S4A).

The angle of view is changed using the zoom mechanism 15, and thus processing in steps S5 to S7 when it is determined in step S3 that the transmitter 2 is within the angle of view is the same as in FIG. 5.

According to the second embodiment, substantially the same advantage as the advantage of the first embodiment can be obtained, and also using a technology to change the angle of view allows the subject 20 to be within the angle of view.

### Modification of Second Embodiment

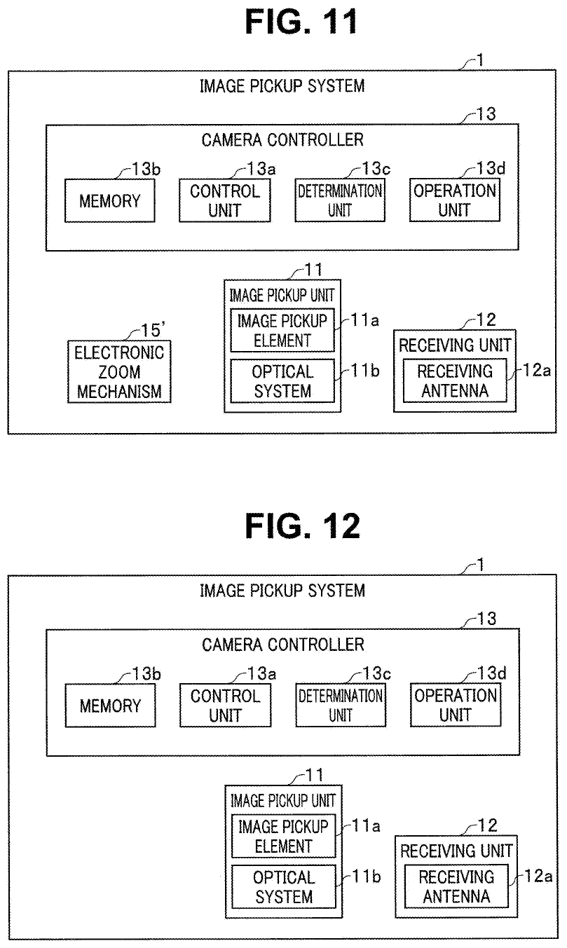

FIG. 11 is a block diagram of a configuration of the image pickup system 1 according to a modification of the second embodiment.

In the configuration in FIG. 8, the zoom mechanism 15 configured to perform optical zooming is adopted as the zoom mechanism, while in the configuration in FIG. 11, an electronic zoom mechanism 15′ configured to perform electronic zooming is adopted. Instead of the zoom optical system 11b1 in FIG. 8, the image pickup system 1 in FIG. 11 includes the optical system 11b.

The electronic zoom mechanism 15′ cuts a part of a picked up image obtained from photoelectric conversion by the image pickup element 11a to obtain an image, and thus changes an angle of view.

The operation of the image pickup system 1 of the modification is the same as the operation in FIG. 10 except that the angle of view is changed by the electronic zooming in step S4A.

The camera 1A may include the zoom optical system 11b1, the zoom mechanism 15 configured to perform the optical zooming, and the electronic zoom mechanism 15′ configured to perform the electronic zooming. Such a configuration performs processing such that, for example, the optical zooming is used in a range in which the angle of view can be changed by the optical zooming, and when a telephoto end of the optical zooming is reached, the zooming is shifted to the electronic zooming. Also in this case, the processing in FIG. 10 can be applied.

The camera 1A according to the embodiment may, of course, include the AF control unit 16, the image authentication unit 17, the illumination device 18, and the microphone 19. In this case, if the illumination device 18 is a zoom illumination device capable of changing an emission range of illumination light, the emission range of illumination light is preferably changed according to the change of the angle of view by the optical zooming or the electronic zooming.

Similarly, if the microphone 19 is a zoom-type microphone capable of changing a range of directivity of voice collection, the range of directivity is preferably changed according to the change of the angle of view.

Further, a result of image authentication (such as face authentication) by the image authentication unit 17 may be used such as to ensure that the subject 20 is within the angle of view even if the angle of view is changed by the zooming.

If the distance between the image pickup system 1 and the subject 20 is changed, for example, from L1 in FIG. 2 to L2 in FIG. 9, zooming may be performed such that a size of the subject 20 in the image is fixed based on distance information to the subject 20 obtained by the AF control unit 16.

The automatic tracking of the subject 20 by the tracking mechanism 14 described in the first embodiment, and the change of the angle of view by the zoom mechanism 15 or 15′ described in the second embodiment may be performed individually or in combination.

When the electronic zooming is performed, automatic tracking can be performed by moving a center position of the range of the cut image within a picked up image. Thus, for the electronic zooming, an electronic tracking mechanism may be used.

### Third Embodiment

### (Configuration)

FIG. 12 is a block diagram of a configuration of an image pickup system 1 according to a third embodiment. In the third embodiment, the same components as in the first and second embodiments are denoted by the same reference numerals and descriptions of such components will be omitted, and differences will be mainly described.

In the first embodiment, the automatic tracking is performed such that the subject 20 is within the angle of view, and in the second embodiment, the angle of view is changed such that the subject 20 is within the angle of view. In contrast, in the third embodiment, start of image pickup is prohibited when the subject 20 is outside the angle of view, and the start of image pickup is permitted when the subject 20 is within the angle of view, such that the subject 20 is within the angle of view.

As shown in FIG. 12, the image pickup system 1 is such that the tracking mechanism 14 is omitted from the image pickup system 1 in FIG. 1. The control unit 13a in the image pickup system 1 controls the start of image pickup by the image pickup unit 11.

### (Operation)

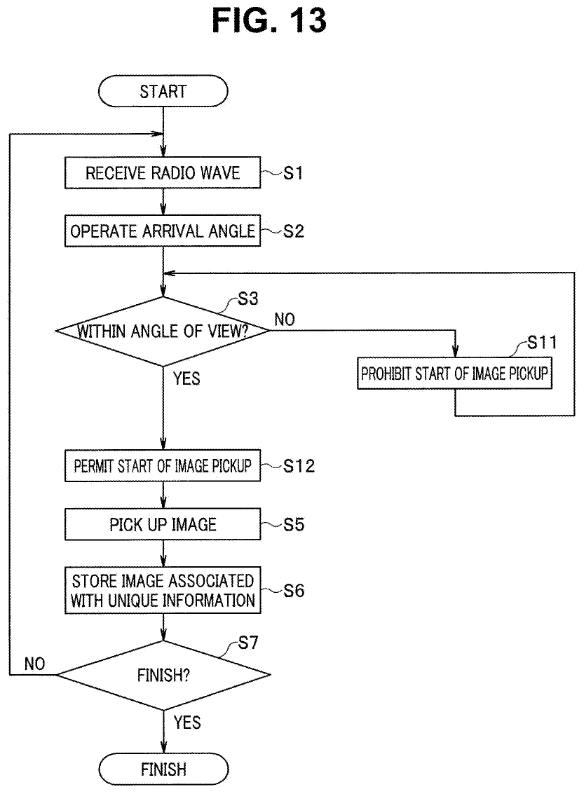

FIG. 13 is a flowchart of an operation of the image pickup system 1 according to the third embodiment.

When processing in FIG. 13 is started, processing in steps S1 to S3 as in FIG. 5 is performed.

If it is determined in step S3 that the transmitter 2 is not within the angle of view, the control unit 13a prohibits the start of image pickup by the image pickup unit 11 (step S11), and returns to the determination processing in step S3. Thus, while it is determined that the transmitter 2 is not within the angle of view, the start of image pickup is continuously prohibited.

If it is determined in step S3 that the transmitter 2 enters the angle of view, the control unit 13a permits the start of image pickup by the image pickup unit 11 (step S12). This allows the start of image pickup of a still image or a moving image.

Subsequent processing in steps S5 to S7 is the same as in FIG. 5.

In the processing in FIG. 13, the start of image pickup is permitted/prohibited according to whether the transmitter 2 is within or outside the angle of view. However, the start of image pickup may be permitted/prohibited based on not only the angle of view but also a detection result by the AF control unit 16 (see FIG. 7).

In this case, if at least one of a fact that it is determined that the transmitter 2 is not within the angle of view or a fact that it is determined that the subject 20 is out of focus is established in step S3, the start of image pickup is prohibited in step S11. On the other hand, if both of a fact that it is determined that the transmitter 2 is within the angle of view and a fact that it is determined that the subject 20 is in focus are established in step S3, the start of image pickup is permitted in step S12.

FIG. 14 is a view showing the image pickup system 1 according to the third embodiment and a plurality of subjects 20 when a group photograph is taken.

The configuration in the embodiment can also be applied to, for example, a case where a group photograph of a plurality of subjects 20 is taken.

In an example in FIG. 14, there are nine persons 20a to 20i as the subjects 20, and the eight persons 20b to 20i have been already within an angle of view of the image pickup system 1. Among the eight persons 20b to 20i, for example, the four persons hold transmitters 2 including respective transmission antennas 22b to 22e. If a group photograph is to be taken, not all of the persons need to hold the transmission antennas 22b to 22e, but only the persons at positions corresponding to edges of the group photograph need to hold the transmission antennas 22b to 22e. The image pickup system 1 can check, based on radio signals RW from the transmission antennas 22b to 22e, that the transmission antennas 22b to 22e are within the angle of view.

On the other hand, the transmitter 2 including the transmission antenna 22a is held by the person 20a. The image pickup system 1 can check, based on a radio signal RW including unique information from the transmission antenna 22a, that the transmission antenna 22a is not within the angle of view.

If a timer photographing function equipped in the camera 1A is used, the person 20a who has pressed a shutter button of the camera 1A has to enter the angle of view within a set time period of a timer. Thus, if there is some distance between the camera 1A and the plurality of subjects 20, the person 20a needs to move toward the plurality of subjects 20 in a hurry.

In contrast, according to the third embodiment, the start of image pickup is prohibited while the transmission antenna 22a of the transmitter 2 held by the person 20a is not within the angle of view, and thus the person 20a does not need to move in a hurry.

The prohibition of the start of image pickup and the timer photographing function may be used in combination. In this case, when it is determined that all of the transmission antennas 22a to 22e enter the angle of view, timer counting of the timer photographing function may be started. This provides a sufficient time period to create good facial expressions at appropriate photographing timing to the persons 20a to 20i including the person 20a who has pressed the shutter button.

The automatic tracking of the subject 20 by the tracking mechanism 14 described in the first embodiment, the change of the angle of view by the zoom mechanism 15 or 15′ described in the second embodiment, and the permission/prohibition of the start of image pickup when the subject 20 is within/outside the angle of view described in the third embodiment may be performed individually, or any two or more of the automatic tracking, the change of the angle of view, and the permission/prohibition of the start of image pickup may be performed in combination.

For example, if a group photograph is to be taken, at least one of the automatic tracking or the change of the angle of view may be further performed such that all of the plurality of subjects 20 are within the angle of view. More specifically, the automatic tracking is performed to make an adjustment such that a center of the plurality of subjects 20 is in the image pickup direction, and the angle of view is changed such that all of the plurality of subjects 20 are within an appropriate range of the angle of view. Then, start of photographing may be prohibited until all of the plurality of subjects 20 enter the angle of view, and the start of photographing may be permitted when all of the plurality of subjects 20 enter the angle of view.

According to the third embodiment, substantially the same advantage as the advantages of the first and second embodiments can be obtained, and also the start of photographing is prohibited until the subject 20 enters the angle of view, thereby ensuring that the subject 20 enters the angle of view.

The case where the invention relates to the image pickup system 1 has been mainly described above. However, the invention may relate to an image pickup method for performing the same operation as the operation of the image pickup system 1.

While certain embodiments have been described, these embodiments have been presented by way of example only, and are not intended to limit the scope of the inventions. Indeed, the novel devices described herein may be embodied in a variety of other forms; furthermore, various omissions, substitutions and changes in the form of the devices described herein may be made without departing from the spirit of the inventions. The accompanying claims and their equivalents are intended to cover such forms or modifications as would fall within the scope and spirit of the inventions.

What is claimed is:

1. An image pickup system comprising:
an image pickup unit configured to pick up an optical image formed by an optical system by means of an image pickup element to obtain an image;
a receiving unit configured to receive a radio signal including unique information transmitted from a transmitter to output the received signal;
an operation unit configured to operate an arrival angle of the radio signal based on the received signal; and
a determination unit configured to determine, based on the arrival angle, whether or not the transmitter is within an angle of view of the image.

2. The image pickup system according to claim 1, wherein the receiving unit includes a plurality of antennas, and
the operation unit operates the arrival angle of the radio signal based on a phase difference of the radio signal received by the plurality of antennas.

3. The image pickup system according to claim 1, further comprising:
a tracking mechanism configured to change an image pickup direction of the image pickup unit; and
a control unit configured to control the tracking mechanism to change the image pickup direction such that the transmitter is within the angle of view if it is determined that the transmitter is not within the angle of view.

4. The image pickup system according to claim 2, further comprising:
a tracking mechanism configured to change an image pickup direction of the image pickup unit; and
a control unit configured to control the tracking mechanism to change the image pickup direction such that the transmitter is within the angle of view if it is determined that the transmitter is not within the angle of view.

5. The image pickup system according to claim 1, further comprising:
a zoom mechanism configured to change the angle of view; and
a control unit configured to control the zoom mechanism to change the angle of view such that the transmitter is within the angle of view if it is determined that the transmitter is not within the angle of view.

6. The image pickup system according to claim 2, further comprising:
a zoom mechanism configured to change the angle of view; and
a control unit configured to control the zoom mechanism to change the angle of view such that the transmitter is within the angle of view if it is determined that the transmitter is not within the angle of view.

7. The image pickup system according to claim 1, further comprising a control unit configured to control start of image pickup by the image pickup unit,
wherein the control unit prohibits the start of image pickup while it is determined that the transmitter is not within the angle of view, and permits the start of image pickup when it is determined that the transmitter enters the angle of view.

8. The image pickup system according to claim 2, further comprising a control unit configured to control start of image pickup by the image pickup unit,
wherein the control unit prohibits the start of image pickup while it is determined that the transmitter is not within the angle of view, and permits the start of image pickup when it is determined that the transmitter enters the angle of view.

9. The image pickup system according to claim 3, wherein the tracking mechanism changes a direction of an optical axis of the optical system.

10. The image pickup system according to claim 4, wherein the tracking mechanism changes a direction of an optical axis of the optical system.

11. The image pickup system according to claim 9, comprising:
a camera including the image pickup unit; and
a camera assisting device on which the camera is installed,
wherein the tracking mechanism is provided in the camera assisting device.

12. The image pickup system according to claim 10, comprising:
a camera including the image pickup unit; and
a camera assisting device on which the camera is installed,
wherein the tracking mechanism is provided in the camera assisting device.

13. The image pickup system according to claim 5, wherein the optical system is a zoom optical system capable of changing a focal length, and
the zoom mechanism changes a focal length of the zoom optical system to change the angle of view.

14. The image pickup system according to claim 6, wherein the optical system is a zoom optical system capable of changing a focal length, and
the zoom mechanism changes a focal length of the zoom optical system to change the angle of view.

15. The image pickup system according to claim 13, comprising a camera including a camera body and an interchangeable lens removably attached to the camera body,
wherein the image pickup element is provided in the camera body, and
the zoom optical system and the zoom mechanism are provided in the interchangeable lens.

16. The image pickup system according to claim 14, comprising a camera including a camera body and an interchangeable lens removably attached to the camera body,
wherein the image pickup element is provided in the camera body, and
the zoom optical system and the zoom mechanism are provided in the interchangeable lens.

17. The image pickup system according to claim 5, wherein the zoom mechanism is an electronic zoom mechanism configured to cut a part of a picked up image obtained by the image pickup element to obtain the image and to thus change the angle of view.

18. The image pickup system according to claim 6, wherein the zoom mechanism is an electronic zoom mechanism configured to cut a part of a picked up image obtained by the image pickup element to obtain the image and to thus change the angle of view.

19. An image pickup method comprising:
picking up a formed optical image to obtain an image;
receiving a radio signal including unique information transmitted from a transmitter to output the received signal;
operating an arrival angle of the radio signal based on the received signal; and
determining, based on the arrival angle, whether or not the transmitter is within an angle of view of the image.
